(19) United States
(12) Patent Application Publication
(10) Pub. No.: US 2012/0281647 A1
(43) Pub. Date: Nov. 8, 2012

(54) METHOD AND APPARATUS TO IMPROVE MACHINE TYPE COMMUNICATION IN A WIRELESS COMMUNICATION SYSTEM

(75) Inventors: Richard Lee-Chee Kuo, Taipei City (TW); Ko-Chiang Lin, Taipei City (TW)

(73) Assignee: INNOVATIVE SONIC CORPORATION, Taipei City (TW)

(21) Appl. No.: 13/463,135

(22) Filed: May 3, 2012

Related U.S. Application Data
(60) Provisional application No. 61/482,100, filed on May 3, 2011.

(51) Int. Cl. H04W 72/04; H04W 24/00

(52) U.S. Cl. 370/329; 370/328

(57) ABSTRACT

A method and apparatus are disclosed to improve machine type communication in a wireless communication system. In one embodiment, the method comprises receiving, at a UE (User Equipment), a TB (transport block) broadcasted from an eNB (evolved Node B). The method further comprises reporting a HARQ (Hybrid Automatic Repeat reQuest) feedback of NACK (Negative Acknowledgement) if the UE does not decode the TB successfully, and not reporting a HARQ feedback of ACK (Acknowledgement) if the UE decodes the TB successfully,

### CROSS-REFERENCE TO RELATED APPLICATIONS

The present Application claims the benefit of U.S. Provisional Patent Application Ser. No. 61/482,100 filed on May 3, 2011, the entire disclosure of which is incorporated herein by reference.

### FIELD

This disclosure generally relates to wireless communication networks, and more particularly, to a method and apparatus to improve machine type communication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to improve machine type communication in a wireless communication system. In one embodiment, the method comprises receiving, at a UE (User Equipment), a TB (transport block) broadcast from an eNB (evolved Node B). The method further comprises reporting a HARQ (Hybrid Automatic Repeat reQuest) feedback of NACK (Negative Acknowledgement) if the UE does not decode the TB successfully. and not reporting a HARQ feedback of ACK (Acknowledgement) if the UE decodes the TB successfully.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 illustrates a message sequence chart in accordance with one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access. 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TS 22.368 V11.1.0, “Service requirements for Machine-Type Communications Stage 1 (Release 11)”; R2-106033, “TR 37,868 V0.7.0 Study on RAN Improvements for Machine-type Communications (Release 10)”; R2-104870, “Pull based RAN overload control”; R2-102125, “Use of Broadcast Solutions for MTC”; R2-102781, “Paging and downlink transmission for MIC”; and TS 36.321 V10.1.0, “MAC protocol specification (Release 10).” The standards and documents listed above are hereby expressly incorporated herein,

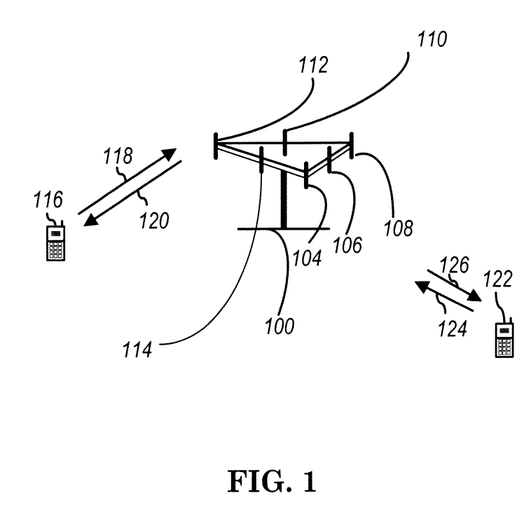

FIG. 1 shows a multiple access wireless communication system according to one embodiment of the invention. An access network 100 (AN) includes multiple antenna groups, one including 104 and 106, another including 108 and 110, and an additional including 112 and 114. FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over yard links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) he a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

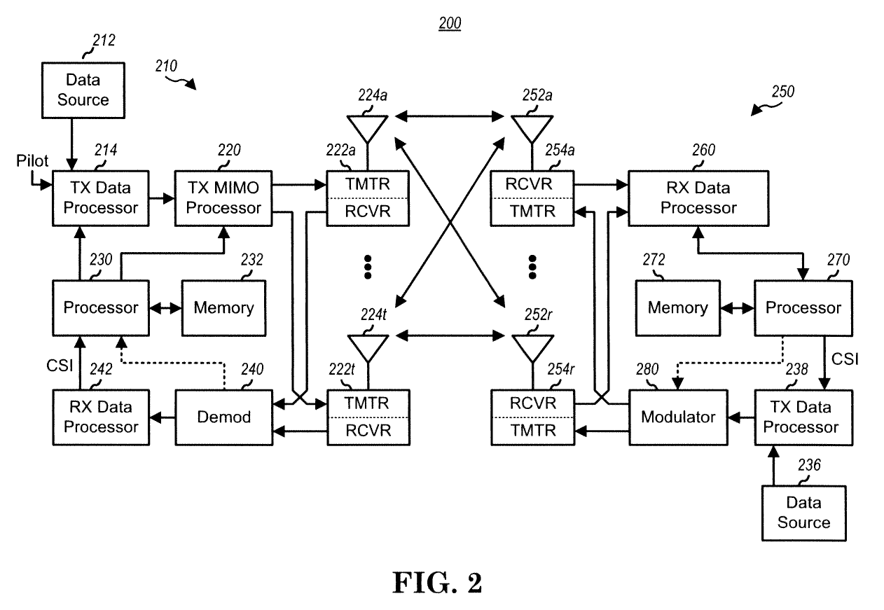

FIG. 2 is a simplified block diagram of an embodiment of a transmitter system 210 (also known as the access network) and a receiver system 250 (also known as access terminal (AT) or user equipment (LTE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250, Processor 230 then determines which pre-coding matrix to use for determining the beamforming weights then processes the extracted message.

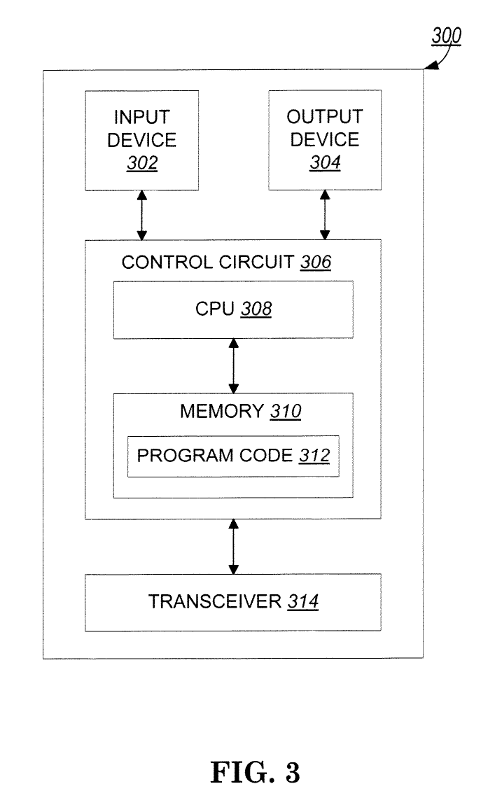

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

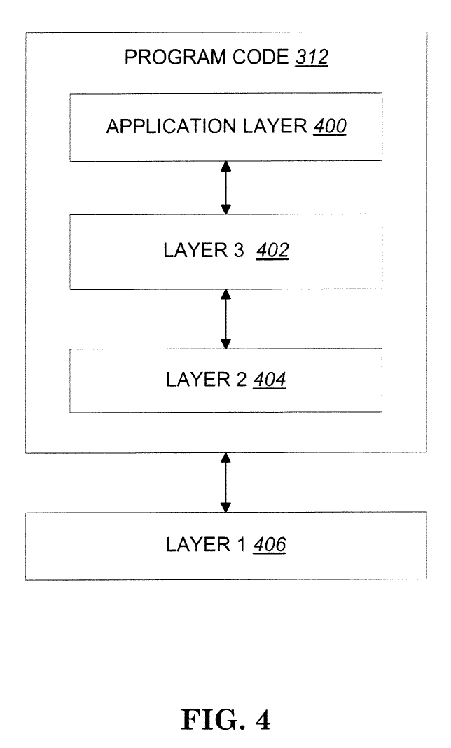

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In general, machine type communication(MTC) is a form of data communication which involves one or more entities that do not necessarily need human interaction. A service optimized for machine type communications may differ from a service optimized for Human to Human communication.

3GPP TS 22.368 specifies the service requirements for Network Improvements for Machine Type Communications, which include service requirements common to all MTC devices and service requirements specific (called MTC features) to certain MTC devices. Based on 3GPP TS 22.368, a MTC Device is generally a UE equipped for Machine Type Communication, which communicates through a PLMN with MTC Server(s) and/or other MTC Device(s). In addition, a MTC Group is generally a group of MTC Devices that share one or more MTC Features and that belong to the same MTC Subscriber. Furthermore, a MTC Server is a server, which communicates to the PLMN itself, and to MTC Devices through the PLMN. The MTC Server also performs services for the MTC User, and has an interface which can be accessed by the MTC User.

RAN overload control was identified as the first priority improvement area in RAN2 for Machine-type Communications. 3GPP TR 37.868 generally captures the output of the Study Item on RAN Improvements for Machine-type Communications. Pull based scheme was considered as a potential scheme for RAN overload control and is described in Section 5.1.3 of 3GPP TR 37.868 as follows:
5.1.3 Pull Based Scheme
If the MTC server is aware of when MTC devices have data to send or the MTC server needs information from the MTC devices, it needs to inform the MTC device. Correspondingly the CN could page the MTC device and upon receiving a paging message the MTC device will perform an RRC connection establishment. The eNB or RNC could control the paging taking into account the network load condition. This is already supported by the current specification.
The paging message may also include a backoff time for the MTC device which indicates the time of access from the reception of the paging message. Another approach would be to use group paging.

Furthermore, 3GPP R2-104870 proposes that group paging is applied for realizing the pull based scheme. For example, all the MTC devices of a MTC group monitor the PDCCH (Physical Downlink Control Channel) addressed to the P-RNTI (Paging Radio Network Temporary Identifier). Once the group identity is found in the received paging message, the MTC devices then take action in response to the paging. The group paging could reduce the paging resources as compared to individual paging for each MTC device of a group. Therefore, group paging could avoid the RAN (Radio Access Network) overload. The backoff time included in the paging message may further avoid the RACH (Random Access Channel) congestion.

In some cases, the network may need to send the same message to a group of MTC devices. If the same message is transmitted to huge MTC devices in a dedicated manner, huge radio resources would be consumed. Also, the MTC devices would need to perform random accesses to the network in order to receive the message in RRC (Radio Resource Control) connected mode, which could cause uplink congestion.

Thus, it would be beneficial if the same message is broadcast on a common channel to the group of MTC devices. It would also be beneficial if the group of MTC devices could receive the same message in RRC idle mode. 3GPP R2-102125 makes the following proposals:
Proposal 1: One of the existing broadcast solutions is used for MTC devices.
Proposal 2: SIB (System Information Block) based broadcast on BCCH (Broadcast Control Channel) is used for transmitting the same MTC message to MTC devices.
Proposal 3: New SIB type is introduced to carry MTC messages
Proposal 4: Transmission of MTC messages on SIB is indicated in paging.

3GPP R2-102781 generally discusses broadcasting the same message to MTC devices. Based on 3GPP R2-102781, broadcasting is efficient way to transmit the same information to multiple MTC devices. Currently, there are two existing broadcasting solutions in UTRAN/E-UTRAN: MBMS (Multimedia Broadcast Multicast Service) based broadcast and SIB (System Information Block) based broadcast. Due to high complexity and cost, MBMS based broadcasting is not considered as an appropriate scheme for data broadcasting in MTC systems. However, SIB based broadcasting also has its drawbacks, such as no ACK (Acknowledgement) feedback, and it is rarely used to send large amount of data. In addition, SIB based solution generally is used to transmit systemic information for all UEs in a certain area, but not for only a group of UEs/MTC devices.

Also according to 3GPP R2-102781, besides MBMS based broadcasting and SIB based broadcasting, another scheme can be considered to broadcast data for MTC device. In this scheme, each MTC group is allocated to a C-RNTI (Cell Radio Network Temporary Identifier) specific to the MTC group. Furthermore, the MTC devices in MTC group use the same C-RNTI to receive common broadcasting data. In addition, the MTC devices could be asked to inform network whether broadcasting data has been received correctly in predefined period.

Regarding MTC broadcasting via a dedicated logical channel mapped to a PDSCH (Physical Downlink Shared Channel), 3GPP R2-102781 considers HARQ (Hybrid Automatic Repeat reQuest) feedback from MTC devices to be helpful. According to 3GPP TS 36.321, a HARQ feedback of ACK (Acknowledgement) would be reported if a Transport Block (TB) is decoded successfully. Otherwise, an HARQ feedback of NACK (Negative Acknowledgement) would be reported.

During an MTC broadcast, different MTC devices may likely have different reception results. In this situation, different contents of HARQ feedback (i.e., ACKs from some MTC devices and NACKs from others) may interfere with each other when they arrive at eNB. As a result, the eNB may not he able to receive the HARQ feedback correctly,

To avoid interference between different contents of HARQ feedback for MTC broadcasting via a dedicated logical channel mapped to a PDSCH (Physical Downlink Shared Channel), a potential solution is that only those MTC devices which do not decode the TB successfully report an HARQ feedback of NACK. Furthermore, HARQ feedback of ACK should not be reported when the TB has been decoded successfully. HARQ feedback of NACK from MTC devices would be helpful for eNB to determine when to stop the MTC broadcasting for an MTC group. For example, eNB (evolved Node B) may continue retransmission if there is any HARQ NACK reported from MTC devices. Otherwise, eNB may stop MTC broadcasting according to a pre-planned schedule.

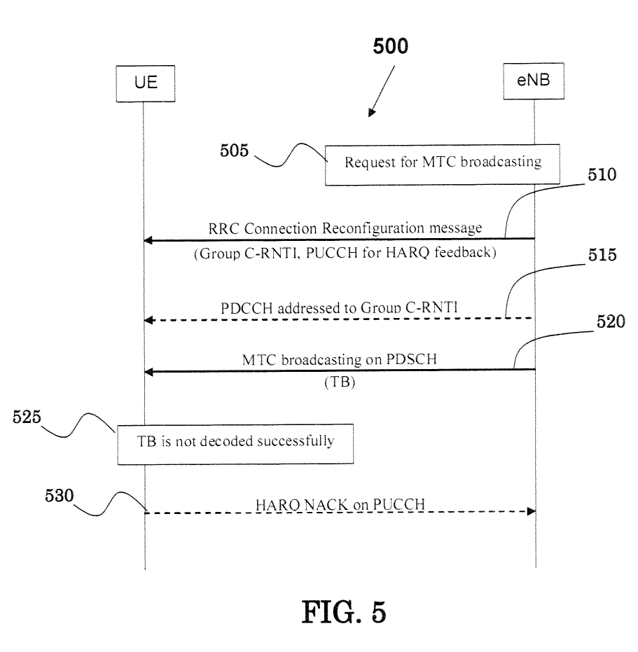

FIG. 5 illustrates a message sequence chart 500 in accordance with one exemplary embodiment. In step 505, a request for MTC broadcasting is generated in the eNB. In step 510, the eNB sends a RRC (Radio Resource Control) Connection Reconfiguration message to the UE. In one embodiment, the C-RNTI specific to the MTC group is configured via a RRC (Radio Resource Control) Connection Reconfiguration message. In this embodiment, the RRC Connection Reconfiguration message includes information about the Group C-RNTI and the PUCCH (Physical Uplink Control Channel) configuration for HARQ feedback.

In step 515, the eNB sends to the UE a PDCCH (Physical Uplink Control Channel) that includes a downlink assignment addressed to the Group C-RNTI. In step 520, the eNB performs a MTC broadcasting on a PDSCH (Physical Downlink Shared Channel) to broadcast a Transport Block (TB) to the UE. In one embodiment, the information or the TB is broadcasted to MTC devices of a MTC group. In this embodiment, an MTC device of the MTC group is configured with a C-RNTI specific to the MTC group for reception of the broadcast information or the TB. Furthermore, each MTC device monitors a PDCCH (Physical Downlink Control Channel) addressed to the C-RNTI specific to the MTC group for receiving the TB transmitted on a PDSCH (Physical Downlink Shared Channel). In one embodiment, the TB or the broadcast information could be transmitted via a dedicated logical channel or a common logical channel mapped to a PDSCH (Physical Downlink Shared Channel). In this embodiment, the dedicated logical channel could be a DTCH (Dedicated Traffic Channel or a DCCII (Dedicated Control Channel).

Returning to FIG. 5, the UE determines that the TB has not been decoded successfully in step 525. In step 530, the UE sends a HARQ feedback of NACK to the eNB since the TB has not been decoded successfully. However, in one embodiment, the UE does not send a HARQ feedback of ACK to the eNB if the TB has been decoded successfully.

Referring back to FIGS. 3 and 4, the UE 300 includes a program code 312 stored in memory 310. In one embodiment, the CPU 308 could execute the program code 312 to (i) receive a TB (transport block) broadcasted from the eNB; and (ii) report a HARQ feedback of NACK if the UE does not decode the broadcast TB successfully, and not report a HARQ feedback of ACK if the UE decodes the broadcast TB successfully.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may he implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules. and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may he any conventional processor, controller, microcontroller, or state machine. A processor may also he implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for receiving broadcast information in a UE (user equipment), comprising:
receiving a TB (transport block) broadcasted from an eNB (evolved Node B); and
reporting a HARQ (Hybrid Automatic Repeat reQuest) feedback of NACK (Negative Acknowledgement) if the UE does not decode the TB successfully. and not reporting a HARQ feedback of ACK (Acknowledgement) if the UE decodes the TB successfully.

2. The method of claim 1, wherein the TB is broadcasted to MTC (Machine Type Communication) devices of an MTC group.

3. The method of claim 2, wherein each MTC device of the MTC group is configured with a C-RNTI (Cell Radio Network Temporary Identifier) specific to the MTC group for reception of the TB.

4. The method of claim 3, wherein each MTC device monitors a PDCCH (Physical Downlink Control Channel) addressed to the C-RNTI specific to the MTC group for receiving the TB transmitted on a PDSCH (Physical Downlink Shared Channel).

5. The method of claim 4, wherein the C-RNTI specific to the MTC group is configured via a RRC (Radio Resource Control) Connection Reconfiguration message.

6. The method of claim 4, wherein the TB is transmitted on a dedicated logical channel mapped to the PDSCH.

7. The method of claim 6, wherein the dedicated logical channel is a DTCH (Dedicated Traffic Channel).

8. The method of claim 6, wherein the dedicated logical channel is a DCCH (Dedicated Control Channel).

9. The method of claim 4, wherein the TB is transmitted on a common logical channel mapped to the PDSCH.

10. A communication device for receiving broadcast information in a UE (User Equipment) in a wireless communication system, the communication device comprising:
a control circuit:
a processor installed in the control circuit;
a memory installed in the control circuit and coupled to the processor;
wherein the processor is configured to execute a program code stored in memory to receive broadcast information by:
receiving a TB (transport block) broadcasted from an eNB (evolved Node B); and
reporting a HARQ (Hybrid Automatic Repeat reQuest) feedback of NACK (Negative Acknowledgement) if the UE does not decode the TB successfully, and not reporting a HARQ feedback of ACK (Acknowledgement) if the UE decodes the TB successfully.

11. The communication device of claim 10, wherein the TB is broadcasted to MTC (Machine Type Communication) devices of an MTC group.

12. The communication device of claim 11, wherein each MTC device of the MTC group is configured with a C-RNTI (Cell Radio Network Temporary Identifier) specific to the MTC group for reception of the TB.

13. The communication device of claim 12, wherein each MTC device monitors a PDCCH (Physical Downlink Control Channel) addressed to the C-RNTI specific to the MTC group for receiving the TB transmitted on a PDSCH (Physical Downlink Shared Channel).

14. The communication device of claim 13, wherein the C-RNTI specific to the MTC group is configured via a RRC (Radio Resource Control) Connection Reconfiguration message.

15. The communication device of claim 13, wherein the TB is transmitted on a dedicated logical channel mapped to the PDSCH.

16. The communication device of claim 15, wherein the dedicated logical channel is a DTCH (Dedicated Traffic Channel).

17. The communication device of claim 15, wherein the dedicated logical channel is a DCCH (Dedicated Control Channel).

18. The communication device of claim 31, wherein the TB is transmitted on a common logical channel mapped to the PDSCH.
